(19) United States
(12) Patent Application Publication
(10) Pub. No.: US 2006/0077187 A1
(43) Pub. Date: Apr. 13, 2006

(54) Coordinate input apparatus having light-emission function and terminal apparatus having the same

(75) Inventors: Hitoshi Shigetaka, Fukushima-ken (JP); Akihisa Itoh, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/239,434

(22) Filed: Sep. 27, 2005

(30) Foreign Application Priority Data
Oct. 8, 2004 (JP) 2004-295675

(51) Int. Cl. G09G 5/00

(52) U.S. Cl. 345/173

(57) ABSTRACT

A coordinate input apparatus includes a sensor (i.e., a detection unit) for detecting an operation status on an operation surface by a coordinate indicator, and a front light (i.e., a lighting unit) disposed on the sensor, for illuminating the operation surface. In the case where the operation surface of the coordinate input apparatus is illuminated, light emitted from a LED is propagated within the light guide plate and then output from the prism surface. The light is reflected from the reflection plate, and directs toward the operation surface with its direction being changed. Accordingly, the operation surface can be illuminated.

### BACKGROUND OF THE INVENTION

1. Field of the Invention

The present invention relates to a coordinate input apparatus and a terminal apparatus having the same. More particularly, the invention relates to a coordinate input apparatus having a light-emission function and a terminal apparatus having the same.

2. Description of the Related Art

Conventionally, portable computer terminal devices such as notebook computers are provided with a coordinate input device called a touch pad. The touch pad is a pointing device for operating the cursor or the pointer displayed on the screen of the terminal apparatus like the mouse, etc. When a user's finger, a pen tip, etc. touch an operation surface of the touch pad, the touch pad senses the contact point using a sensor. The touch pad operates the cursor or the pointer according to a coordinate value of the contact point or the displacement of the coordinate value by movement of the contact point.

There has been disclosed one in which a sensor is formed using a sheet with light transmission and a color LCD panel having a backlight, for illuminating the operation surface, is disposed at the bottom of the sensor in this coordinate input apparatus.

In the coordinate input apparatus, however, the color LCD panel having the backlight is disposed at the bottom of the sensor. Thus, light of the backlight is output to the outside through the color LCD and the sensor. Accordingly, there is a problem in that a sufficient amount of light cannot be obtained because light of the backlight is absorbed by the LCD or the sensor. There are also problems in that the sensor must be formed of a material with light transmission, which increases the cost.

### SUMMARY OF THE INVENTION

The invention has been made in view of the above problems, and it is an object of the invention to provide a coordinate input apparatus and a terminal apparatus having the same, wherein an operation surface can be illuminated in a more efficient manner.

A coordinate input apparatus, which has an operation surface operated by a coordinate indicator according to the invention, includes a detection unit for detecting an operation status on the operation surface, and a lighting unit disposed on the detection unit, for illuminating the operation surface.

In accordance with this construction, the lighting unit is disposed on the detection unit and other members are not disposed on the lighting unit. Therefore, light of the lighting unit can be used for lighting of the operation surface in an effective way. Due to this, the coordinate input apparatus of the invention can efficiently illuminate the operation surface.

In the coordinate input apparatus of the invention, the lighting unit may include a light source, and a light guide unit having a prism surface on the detection unit side, for directing light from the light source toward the operation surface.

In the coordinate input apparatus of the invention, it is preferable that a reflection member be disposed between the detection unit and the light guide unit.

A terminal apparatus having the coordinate input apparatus according to the invention includes a light source control unit for controlling the light source based on the function of the terminal apparatus or the detection unit.

According to this construction, the operation surface can be illuminated based on the function of the terminal apparatus or the detection unit. Therefore, a user can visually see the function of the terminal apparatus or the detection unit, and at the same time, a decorative effect can be produced.

### BRIEF DESCRIPTION OF THE DRAWINGS

FIG. 1 is a view showing a schematic construction of a terminal apparatus having a coordinate input apparatus according to an embodiment of the invention;

FIG. 2 is a view showing the internal construction of a PC main body in the terminal apparatus shown in FIG. 1;

FIG. 3 is a view showing the internal construction of a controller in the terminal apparatus shown in FIG. 1; and

FIG. 4 is a view showing the internal construction of a sensor in the terminal apparatus shown in FIG. 1.

### DESCRIPTION OF THE PREFERRED EMBODIMENT

Preferred embodiments of the invention will now be described with reference to the drawings.

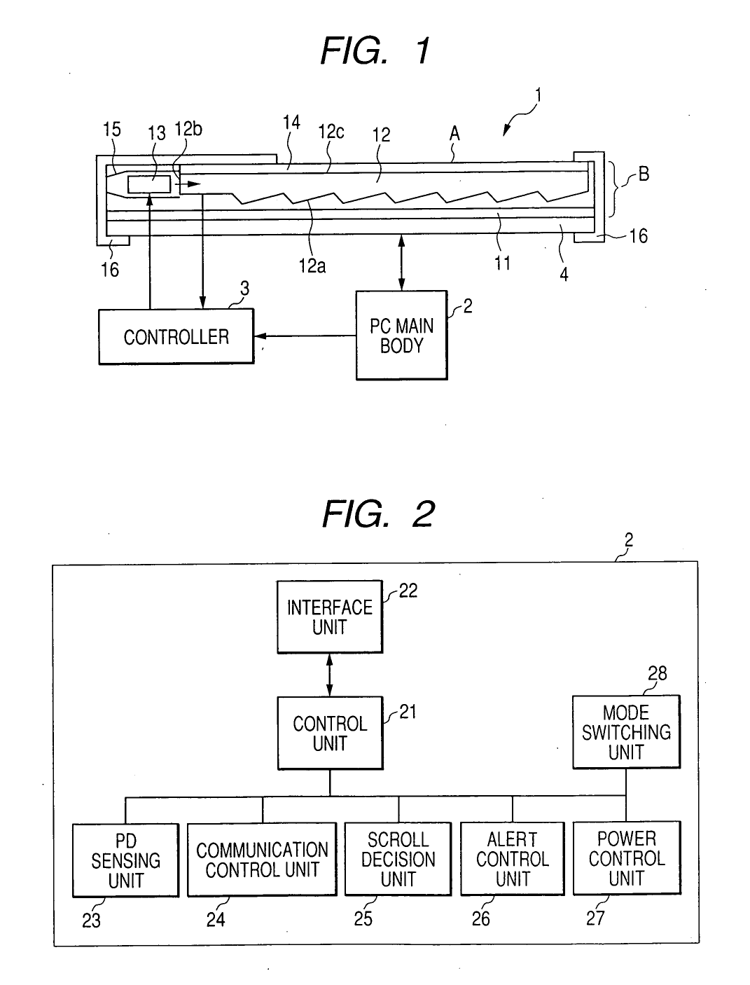

FIG. 1 is a view showing a schematic construction of a terminal apparatus having a coordinate input apparatus according to an embodiment of the invention.

The terminal apparatus shown in FIG. 1 includes a coordinate input apparatus 1, which has an operation surface operated by a coordinate indicator such as a user's finger and can illuminate the operation surface using a light source, a PC main body 2 in which pointing is performed according to the input of the coordinate input apparatus 1, wherein the PC main body is electrically connected to the coordinate input apparatus 1, and a controller 3 that controls the light source of the coordinate input apparatus based on the functions of the coordinate input apparatus 1 and the PC main body 2. The coordinate input apparatus 1 is embedded in the PC main body 2.

The coordinate input apparatus 1 includes a sensor 4 (i.e. a detection unit of capacitive mode) for detecting an operation status on an operation surface A operated by a coordinate indicator such as a finger, and a front light B (i.e., a lighting unit) disposed on the sensor 4, for illuminating the operation surface A. The front light B has a flat panel shape, and it includes a light guide plate 12 having a prism surface 12a on the side of the sensor 4, a LED 13 (i.e., a light source) disposed near an end face 12b of the light guide plate 12, and a light diffusion plate 14 disposed on a flat surface 12c opposite to the prism surface 12a of the light guide plate 12. A crimp process, etc. is performed on the light diffusion plate 14 for a better manipulation since a user's finger (i.e., a coordinate indicator) directly touches the light diffusion plate 14. As described above, by performing the crimp process on the surface of the light diffusion plate 14, operability can be improved and reflection of external light can be prevented. Since the thickness of the light guide plate 12 is 0.5 to 1.5 mm, it does not hider the movement of the coordinate indicator and detection of an electrostatic change in the operation status by the coordinate input apparatus 1 although the light guide plate 12 is interposed between the coordinate indicator and the coordinate input apparatus 1.

A reflection plate 11 is disposed between the sensor 4 and the prism surface 12a of the light guide plate 12. Further, the LED 13 is covered with a case 15. In addition, the sensor 4 and the front light B have their both ends fixed by the fixed frame 16 so that they integrate.

Furthermore, the sensor 4 of the coordinate input apparatus 1 is electrically connected to the PC main body 2 and the controller 3. In addition, the controller 3 is electrically connected to the LED 13 and controls the LED 13 in various ways.

A user can move the cursor (or the pointer) on the screen of the PC main body 2 by locating his finger on a region (the operation surface) of the light diffusion plate 14, which corresponds to the sensor 4 of the coordinate input apparatus 1 constructed above, and then scrolling the finger without change. Furthermore, a user can perform various operations, such as selection or movement of an object displayed on the screen, like clicking on the left button of the mouse by softly striking the operation surface A (a tap operation) using his finger. A user can also perform operations such as application start-up, like double clicking on the mouse, by tapping the operation surface A twice. Furthermore, a user can move an object to a desired location by performing the tap operation with the cursor being focused on the object on the screen and then moving the cursor (a slide operation, a drag operation). A scroll bar region is further provided in the operation surface A. A user can perform scrolling the screen by sliding the finger in the scroll bar region (a scroll operation).

In the case where the operation surface A of the coordinate input apparatus 1 is illuminated, light emitted from the LED 13 is propagated within the light guide plate 12 and then output from the prism surface 12a toward the operation surface A. The operation surface A is illuminated accordingly. Further, a low angle of the prism disposed in the prism surface 12a of the light guide plate 12 is not specially limited if light from the LED 13 can be oriented toward the operation surface A, as described above.

The front light B is provided in the coordinate input apparatus 1. That is, the lighting unit is disposed on the sensor 4, and other members are not disposed on the lighting unit. Thus, light of the lighting unit can be used to effectively illuminate the operation surface A. Furthermore, since the sensor 4 is disposed under the lighting unit, the sensor 4 needs not to be formed of a transparent material. This is advantageous in terms of the cost. As described above, the coordinate input apparatus according to the present embodiment can illuminate the operation surface A in an efficient way by controlling the LED 13 based on the function of the PC main body 2 or the sensor 4.

An internal structure of each of the components of the terminal apparatus shown in FIG. 1 will be described below. FIG. 2 is a view showing the internal construction of the PC main body in the terminal apparatus shown in FIG. 1. The PC main body 2 shown in FIG. 2 includes a control unit 21 for controlling the overall operation of the PC, an interface unit 22 (i.e., a communication port) for providing communication among respective components, a PD (pointing device) sensing unit 23 for sensing whether a PD, such as a mouse, has been mounted in the PC main body 2, a communication control unit 24 for controlling a network computing system, e-mail, and the like, a scroll decision unit 25 for deciding a scroll operation in the PD or the coordinate input apparatus 1, an alert control unit 26 for controlling various warnings within the PC main body 2, a power control unit 27 for monitoring the ON/OFF of power or the remaining battery level, and a mode switching unit 28 for executing switching of mode in which the coordinate input apparatus is used as operations other than cursor operation. The PC main body 2 further includes the functions of a common computer, and thus has all processing units, which are included in a common computer, other than the aforementioned processing units.

The PD sensing unit 23 detects that a PD has been connected to the PC main body 2 so as to operate in cooperation with the PC main body 2. The communication control unit 24 performs access control to a network such as an Internet, realizing a browser function or an e-mail function. The scroll decision unit 25 determines whether scroll is performed on the screen of the PC main body 2 according to a control signal of a sensor substrate 43, and performs scrolling. The alert control unit 26 controls an alert to be generated when a failure or abnormality happens in the PC main body 2 or it is necessary to warn or report a user. The power control unit 27 monitors the ON/OFF of power or the remaining battery level. The mode switching unit 28 controls switching of mode when the coordinate input apparatus 1 is used as other uses than the pointing device (operations other than cursor operation, such as the input of characters).

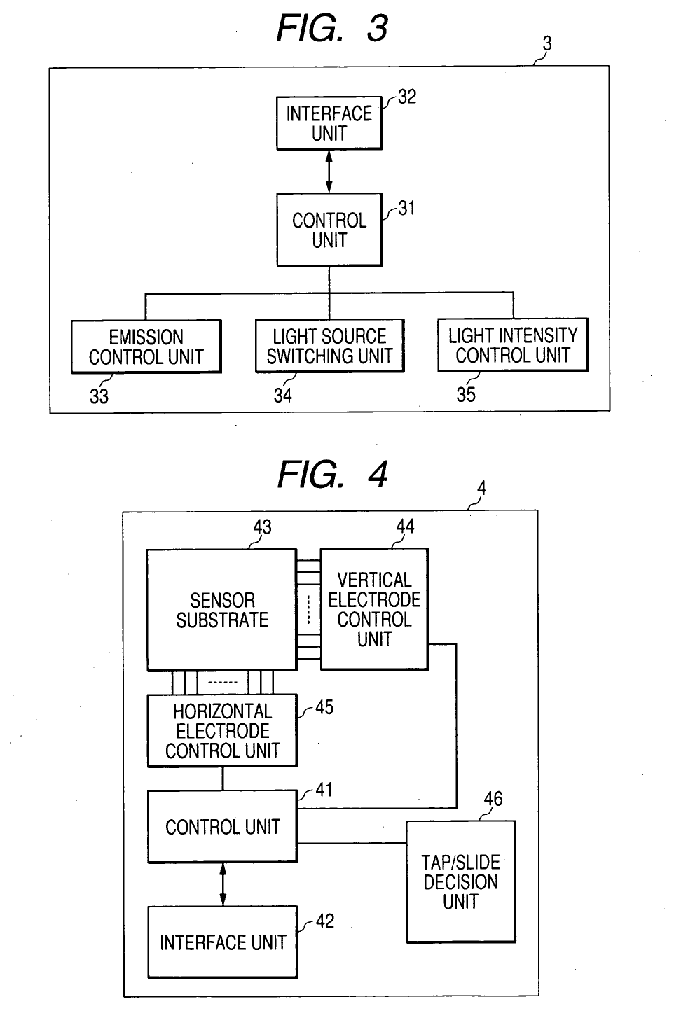

FIG. 3 is a view showing the internal construction of the controller in the terminal apparatus shown in FIG. 1. The controller 3 shown in FIG. 3 includes a control unit 31 for controlling the overall operation of the apparatus, an interface unit 32 (i.e., a communication port) for providing communication among respective components, an emission control unit 33 for controlling ON/OFF of emission or flickering, a light source switching unit 34 for switching a plurality of LEDs 13, and a light intensity control unit 35 for changing the brightness of the LEDs 13.

The emission control unit 33, the light source switching unit 34, and the light intensity control unit 35 are all control means for controlling the LED 13 (i.e., the light source) according to the function of the PC main body 2 or the sensor 4. The emission control unit 33 serves to turn on or off the LED 13 according to the function of the PC main body 2 or the sensor 4 so as to light or put out the LED 13, or to flicker the LED 13. The light source switching unit 34 switches LEDs when lights are lighted using a plurality of LEDs, more particularly, plural colors of LEDs are lighted according to the function of the PC main body 2 or the sensor 4. The light intensity control unit 35 changes the brightness of the LED 13 according to the function of the PC main body 2 or the sensor 4. Furthermore, the emission control unit 33, the light source switching unit 34, and the light intensity control unit 35 can control the LEDs independently, or control a light source control unit to emit light, switch the light source and adjust the amount of light.

FIG. 4 is a view showing the internal construction of the sensor in the terminal apparatus shown in FIG. 1. The sensor 4 shown in FIG. 4 includes a control unit 41 for controlling the overall operation of the apparatus, an interface unit 42 (i.e., a communication port) for providing communication among respective components, the sensor substrate 43, a vertical electrode control unit 44 for controlling vertical electrodes connected to the sensor substrate 43, a horizontal electrode control unit 45 for controlling horizontal electrodes connected to the sensor substrate 43, and a tap/slide decision unit 46 for determining whether a tap operation or a slide operation has been executed on the operation surface A.

The sensor substrate 43 shown in FIG. 4 has a plurality of vertical electrodes and a plurality of horizontal electrodes, each disposed on a front surface and a rear surface of a film. The vertical electrodes and the horizontal electrodes are disposed in a matrix. If a user's finger touches the operation surface A of the coordinate input apparatus 1 having the sensor substrate 43 constructed above, capacitance at the contact portion in the sensor substrate 43 is decreased. This change in the capacitance is converted into change in a current value, thus detecting the amount of variation in each electrode. The location of the finger is detected in a vertical direction and a horizontal direction, respectively, based on the amount of variations in the respective electrodes. In this case, a case where the sensor substrate 43 is capacitively constructed has been described. In the invention, however, the sensor substrate 43 can be constructed in other methods such as pressure-sensitive method.

The vertical electrode control unit 44 is a circuit that scans the sensor substrate 43 in the vertical direction, and generates a serial detection signal indicating the scanning state of a user's finger. The serial detection signal includes a tap component generated when the finger is tapped to the operation surface A of the sensor substrate 43, and a slide component generated when the finger slides on the operation surface A. The horizontal electrode control unit 45 is a circuit that scans the sensor substrate 43 in the horizontal direction. In this case, the tap component includes an address component indicating a location at which the finger touches the operation surface A. The slide component includes an address component indicating from which location to which location the finger slides on the operation surface A.

The tap/slide decision unit 46 determines whether a tap operation is executed or a slide operation is executed.

In the terminal apparatus having the above-described construction, a variety of applications for light-emitting the operation surface A will be described.

(1) A control process of illuminating the operation surface A when the coordinate input apparatus 1 is ON and not illuminating the operation surface A when the coordinate input apparatus 1 is OFF, i.e., a PD such as a mouse is connected to the PC main body 2 is performed.

When any PD is not connected to the PC main body 2, the controller 3 light-emits a LED 13. Therefore, the operation surface A is illuminated by the front light B, as described above. If a PD is connected to the PC main body 2, the PD sensing unit 23 senses that the PD has been connected to the PC main body 2 and then outputs a control signal of that effect. The control signal is sent to the emission control unit 33 through the interface unit 22 of the PC main body 2 and the interface unit 32 of the controller 3. The emission control unit 33 turns off the LED 13 according to the control signal. Accordingly, when an input operation is possible in the coordinate input apparatus, the operation surface A can be illuminated without connecting the PD.

(2) A control process of illuminating the operation surface A when a user's finger touches the operation surface A is performed.

When a user's finger touches the operation surface A, the sensor substrate 43 of the sensor 4 senses that the finger has touched the operation surface A based on variations in capacitance and then outputs its control signal. The control signal is sent to the emission control unit 33 through the interface unit 42 of the sensor 4 and the interface unit 32 of the controller 3. The emission control unit 33 turns on the LED 13 according to the control signal. Therefore, when a user's finger touches the operation surface A, the operation surface A can be illuminated.

As described above, in the event that the operation surface A is illuminated when a user's finger touches the operation surface A, the method of illuminating the operation surface A can be changed in the scroll operation, the tap operation, or the slide operation. For example, if a user performs the scroll operation, a control signal is output from the sensor substrate 43. The scroll decision unit 25 that has received the control signal determines whether the scroll operation is being executed on the screen of the PC main body 2 and performs the scroll operation. In this case, the scroll decision unit 25 outputs a control signal for the scroll operation. The control signal is sent to the emission control unit 33, the light source switching unit 34 and/or the light intensity control unit 35 through the interface unit 22 of the PC main body 2 and the interface unit 32 of the controller 3. The emission control unit 33, the light source switching unit 34 and/or the light intensity control unit 35 select a LED or the amount of light according to the control signal so that an operation corresponding to the scroll operation can be carried out, and then turn on the selected LED.

Furthermore, in the event that a user performs the tap operation or the slide operation, the tap/slide decision unit 46 determines whether the tap operation or the slide operation is being executed based on variations in capacitance sensed by the sensor substrate 43. In this case, if the tap operation or the slide operation is being executed, the tap/slide decision unit 46 outputs a control signal of that effect. The control signal is sent to the emission control unit 33, the light source switching unit 34 and/or the light intensity control unit 35 through the interface unit 42 of the sensor 4 and the interface unit 32 of the controller 3. The emission control unit 33, the light source switching unit 34 and/or the light intensity control unit 35 select a LED or the amount of light according to the control signal so that an operation corresponding to the tap operation or the slide operation can be carried out, and then turn on the selected LED.

(3) A control process of illuminating the operation surface A with a color different from that in the case of coordinate input when a user employs the coordinate input apparatus for uses other than the input of coordinates, e.g., the input of characters is performed.

In the case where a user employs the coordinate input apparatus for uses other than the input of coordinates, e.g., the input of characters, the mode switching unit 28 of the PC main body 2 outputs a control signal indicating that the coordinate input apparatus is employed as the input of characters. The control signal is sent to the light source switching unit 34 through the interface unit 22 of the PC main body 2 and the interface unit 32 of the controller 3. The light source switching unit 34 selects a LED used when the coordinate input apparatus is employed for the input of characters according to the control signal. In this state, the emission control unit 33 turns on/off the selected LED. Accordingly, the operation surface A can be illuminated with a color different from that in the case of coordinate input when a user employs the coordinate input apparatus for uses other than the input of coordinates, e.g., the input of characters.

(4) A control process of illuminating the operation surface A when the PC main body 2 receives e-mail is performed.

If the PC main body 2 receives e-mail, the communication control unit 24 of the PC main body 2 outputs a control signal indicating that e-mail has been received. The control signal is sent to the light source switching unit 34 through the interface unit 22 of the PC main body 2 and the interface unit 32 of the controller 3. The light source switching unit 34 selects a LED that is used when e-mail is received according to the control signal. In this state, the emission control unit 33 turns on/off the selected LED. Accordingly, the operation surface A can be illuminated when the PC main body 2 receives e-mail.

(5) A control process of turning on the PC main body 2 and illuminating the operation surface A when a user is in standby state is performed.

If the PC main body 2 is turned on, the power control unit 27 of the PC main body 2 outputs a control signal indicating that power has been turned on. The control signal is sent to the emission control unit 33 through the interface unit 22 of the PC main body 2 and the interface unit 32 of the controller 3. The emission control unit 33 turns on a LED according to the control signal. Accordingly, the PC main body 2 is turned on and the operation surface A can be illuminated when a user is in standby state. Further, since the power control unit 27 monitors the remaining battery level, when the remaining battery level is lower than a predetermined remaining battery level, it can output a control signal of that effect. The color of a LED can be changed in the light source switching unit.

(6) A control process of illuminating the operation surface A when issuing various warning within the PC main body 2 is performed.

If a warning is necessary within the PC main body 2, the alert control unit 26 of the PC main body 2 outputs a control signal indicating that an alert will be issued. The control signal is sent to the emission control unit 33 through the interface unit 22 of the PC main body 2 and the interface unit 32 of the controller 3. The emission control unit 33 turns on a LED according to the control signal. Accordingly, when various warnings within the PC main body 2 are issued, the operation surface A can be illuminated. Further, by previously correlating the type of an alert and the color of a LED, the alert control unit 26 can output a control signal including the type of an alert to the light source switching unit 34, the light source switching unit 34 can select a LED of the color related to the alert, and in this state, the emission control unit 33 can turns on/off the LED. Accordingly, the type of an alert can be visually seen according to a light-emitting color.

As described above, in the present embodiment, the operation surface A can be illuminated based on the function of the PC main body 2 or the sensor 4. Accordingly, a decorative effect can be obtained while visually seeing the function of the PC main body 2 or the sensor 4. The function of the PC main body 2 or the sensor 4 is not limited to the above. It is to be understood that the invention can be applied to a case where the operation surface A is illuminated in connection with a function that can be performed by the PC main body 2 or the sensor 4.

The invention is not to be restricted by the embodiments, but can be modified in various ways. For example, in the above-mentioned embodiment, optical components such as the light guide plate, the reflection plate and the light diffusion plate are not limited to the plate shape, but can have a film shape, a sheet shape or the like. Furthermore, in the above-mentioned embodiment, a case where the light source is a LED has been described. In the invention, however, the light source can include things other than the LED. In addition, the invention can be properly modified without departing from the scope and spirit of the invention.

According to the invention, the coordinate input apparatus includes a detection unit for detecting an operation status on an operation surface, and a lighting unit disposed on the detection unit, for illuminating the operation surface. Accordingly, light of the lighting unit can be used for lighting of the operation surface in an effective way. Consequently, the operation surface can be efficiently illuminated.

1. A coordinate input apparatus having an operation surface operated by a coordinate indicator, comprising:
a detection unit for detecting an operation status on the operation surface; and
a lighting unit disposed on the detection unit, for illuminating the operation surface.

2. The coordinate input apparatus according to claim 1, wherein the lighting unit includes a light source, and a light guide unit having a prism surface on the detection unit side, for directing light from the light source toward the operation surface.

3. The coordinate input apparatus according to claim 1, wherein a reflection member is disposed between the detection unit and the light guide unit.

4. The terminal apparatus including the coordinate input apparatus according to claim 1, further comprising:
a light source control unit for controlling a light source based on the function of the terminal apparatus or detection unit.

5. A coordinate input apparatus comprising:
a sensor unit for detecting an operation status on an operation surface by a coordinate indicator;
a lighting unit having a light source and a light guide plate; and
a control unit for controlling a display screen state of an electronic device according to a signal received from the sensor unit,
wherein the light guide plate and the sensor unit are at least partially overlapped, and while the sensor unit is illuminated by light-emission of the light source, the light-emission status of the light source is switched based on a signal from the control unit, thus visually changing the operation status.

6. The coordinate input apparatus according to claim 5, wherein the control unit switches the light-emission status of the light source depending on whether the coordinate indicator has touched the operation surface.

7. The coordinate input apparatus according to claim 5, wherein the control unit switches the light-emission status of the light source depending on the operation status on the operation surface operated by the coordinate indicator.

8. The coordinate input apparatus according to claim 2, wherein a reflection member is disposed between the detection unit and the light guide unit.

9. The terminal apparatus including the coordinate input apparatus according to claim 2, further comprising:
a light source control unit for controlling a light source based on the function of the terminal apparatus or detection unit.

10. The terminal apparatus including the coordinate input apparatus according to claim 3, further comprising:
a light source control unit for controlling a light source based on the function of the terminal apparatus or detection unit.

11. The terminal apparatus including the coordinate input apparatus according to claim 8, further comprising:
a light source control unit for controlling a light source based on the function of the terminal apparatus or detection unit.
